(19) United States
(12) Patent Application Publication
(10) Pub. No.: US 2016/0024999 A1
(43) Pub. Date: Jan. 28, 2016

(54) TURBINE HOUSING WITH DIVIDING VANES IN VOLUTE

(71) Applicant: BORGWARNER INC., Auburn Hills, MI (US)

(72) Inventors: David G. Grabowska, Asheville, NC (US); Adam R. Reinke, Arden, NC (US)

(21) Appl. No.: 14/653,946

(22) PCT Filed: Dec. 2, 2013
(86) PCT No.: PCT/US2013/072587

§ 371 Date: Jun. 19, 2015

Related U.S. Application Data
(60) Provisional application No. 61/739,985, filed on Dec. 20, 2012.

(51) Int. Cl. F02B 37/24; F02M 25/07; F01D 25/24; F01D 17/14; F01D 5/02; F01D 9/02

(52) U.S. Cl. CPC F02B 37/24; F01D 5/02; F01D 9/02; F01D 25/24; F01D 17/14; F02M 25/077

(57) ABSTRACT

A turbocharger turbine (10) having a turbine wheel (12) and a turbine housing (14) with a volute (20). The turbine housing (14) has dividing vanes (24) in the curved portion (22) of the volute (20) for use with a turbine (10) as mixed-flow or axial-flow. A valve (36) controls exhaust gas flow to one or both of an outer volute portion (26) and an inner volute portion (28) formed on each side of the dividing vanes (24).

### CROSS-REFERENCE TO RELATED APPLICATION

This application claims priority to and all benefits of U.S. Provisional Application No. 61/739,985, filed on Dec. 20, 2012, and entitled “Turbine Housing With Dividing Vanes In Volute.”

### BACKGROUND

1. Field of the Disclosure

This disclosure relates to exhaust gas-driven turbochargers having a turbine housing with dividing vanes in a curved portion of a volute. More particularly, this disclosure relates to a variable turbine volute turbine housing having dividing vanes for use with a mixed-flow or axial-flow turbine.

2. Description of Related Art

Advantages of turbocharging include increased power output, lower fuel consumption and reduced pollutant emissions. The turbocharging of engines is no longer primarily seen from a high-power performance perspective, but is rather viewed as a means of reducing fuel consumption and environmental pollution on account of lower carbon dioxide (CO₂) emissions. Currently, a primary reason for turbocharging is using exhaust gas energy to reduce fuel consumption and emissions. In turbocharged engines, combustion air is pre-compressed before being supplied to the engine. The engine aspirates the same volume of air-fuel mixture as a naturally aspirated engine, but due to the higher pressure, thus higher density, more air and fuel mass is supplied into a combustion chamber in a controlled manner. Consequently, more fuel can be burned, so that the engine's power output increases relative to the speed and swept volume.

In exhaust gas turbocharging, some of the exhaust gas energy, which would normally be wasted, is used to drive a turbine. The turbine includes a turbine wheel that is mounted on a shaft and is rotatably driven by exhaust gas flow. The turbocharger returns some of this normally wasted exhaust gas energy back into the engine, contributing to the engine's efficiency and saving fuel. A compressor, which is driven by the turbine, draws in filtered ambient air, compresses it, and then supplies it to the engine. The compressor includes a compressor impeller that is mounted on the same shaft so that rotation of the turbine wheel causes rotation of the compressor impeller.

Turbochargers typically include a turbine housing connected to the engine's exhaust manifold, a compressor housing connected to the engine's intake manifold, and a center bearing housing coupling the turbine and compressor housings together. The turbine housing defines a volute that surrounds the turbine wheel and that receives exhaust gas from the engine. The turbine wheel in the turbine housing is rotatably driven by an inflow of exhaust gas supplied from the exhaust manifold.

There are three primary turbine types used in turbochargers: axial, radial and mixed-flow. In axial-flow turbines, exhaust gas flow through the turbine wheel is only in the axial direction. In radial-flow turbines, exhaust gas inflow is centripetal, i.e. in a radial direction from the outside in, and exhaust gas outflow is typically in the axial direction. Initial exhaust gas flow is perpendicular to the axis of rotation. In mixed-flow turbines, the exhaust gas flow approaches the turbine wheel in a direction between the axial direction and the radial direction.

An axial or a mixed-flow turbine typically has lower flow resistance than a radial-flow turbine. Often, axial-flow turbines can be more efficient because the exhaust gas is forced directly against the entire turbine wheel while for radial-flow turbines the exhaust gas flows from the side of the turbine wheel and then around the perimeter of the turbine wheel.

Various types of turbochargers are known to have differing capabilities, sizes, characteristics and cost.

A traditional wastegate turbocharger often operates in a binary fashion, but is low cost. A wastegate valve assembly in the turbine housing may include a valve, vent and/or bypass that is able to selectively route a portion of the exhaust gas around (i.e. bypassing) the turbine, in order to limit/control turbine work, thus only utilizing a fraction of the available exhaust energy that could be extracted from the exhaust gas flow. Thereby, the wastegate valve assembly regulates exhaust gas flow and ensures that the turbine wheel is not spun at an undesirable speed.

A variable turbine geometry (VTG) turbocharger is a more complex and expensive option, not using a wastegate valve assembly. The variable turbine geometry allows a turbine flow cross-section leading to the turbine wheel to be varied in accordance with engine operating points. This allows the entire exhaust gas energy to be utilized and the turbine flow cross-section to be set optimally for each operating point. As a result, the efficiency of the turbocharger and hence that of the engine can be higher than that achieved with the bypass control of a wastegate valve assembly. Variable guide vanes in the turbine have an effect on pressure build-up behavior and, therefore, on the turbocharger power output.

This disclosure focuses on a variable turbine volute turbine housing for turbochargers having a mixed-flow or axial-flow turbine.

### SUMMARY

A variable turbine volute (VTV) turbine housing is an intermediate cost option that enables exhaust gas recirculation while supporting improved fuel economy. A VTV turbine housing typically provides more control than a traditional wastegate valve assembly. The VTV turbine housing increases backpressure more than the wastegate valve assembly, allowing exhaust gas to be recirculated as needed.

Also, an axial or mixed-flow turbine offers lower inertia than a radial-flow turbine as a key advantage, but it reduces flow resistance through the turbine thereby making exhaust gas recirculation difficult. For typical axial or mixed-flow turbines, the inability to regulate gas flow through the turbine and a reduced ability to drive exhaust gas recirculation are addressed.

Adapting a VTV turbine housing to an axial-flow turbine raises a special consideration. Parallel walls across the vanes that are typically used cause space and casting difficulties for an axial-flow turbine. The vanes can be tilted relative to an axis of rotation allowing a surface on the opposite wall for both thermal growth and sealing the vane tips.

This disclosure provides further for a VTV turbine housing having dividing vanes in a curved portion of the volute for use with a mixed-flow or axial-flow turbine. This can deliver appropriate gas flow to a non-radial turbine wheel. The volute with dividing vanes in the curved portion in combination with an axial-flow turbine assists with improved exhaust gas delivery.

The VTV turbine housing is combined with an axial or mixed-flow turbine. Due to space requirements of an axial or mixed-flow turbine, the VTV turbine housing incorporates dividing vanes into the volute. A prior art flat plate with vanes is not preferred with axial and mixed-flow turbines since the housing diameter may be too large. The VTV turbine housing can operate in a smaller space than a flat plate with vanes.

The presently disclosed variable turbine volute turbine housing with dividing vanes in the curved portion improves exhaust gas recirculation as part of a mixed-flow or axial-flow turbine while maintaining the benefits of lower inertia.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a cross-sectional view of a turbine housing with a valve at the inlet and dividing vanes between inner and outer volute portions;

FIG. 2 is a cross-sectional view of a turbine housing with a dividing vane attached on the hub side between inner and outer volute portions; and

FIG. 3 is cross-sectional view of a turbine housing with a dividing vane attached on the shroud side between inner and outer volute portions.

### DETAILED DESCRIPTION OF THE EMBODIMENTS

A turbocharger is generally known and includes a turbine 10 and a compressor, wherein a compressor impeller is rotatably driven via a shaft by a turbine wheel 12. The shaft passes through a bearing housing between a turbine housing 14 and a compressor housing.

A variable turbine volute (VTV) turbine housing 14 enables controlled delivery of exhaust gas flow. In an axial-flow turbine, gas flow through the turbine wheel 12 is only in an axial direction. For a mixed-flow turbine, gas flow approaches the turbine wheel 12 in a direction between the axial direction and a radial direction. Both such turbine wheels 12 are non-radial.

The turbine 10 consists of a turbine wheel 12 and a VTV turbine housing 14. The turbine 10 converts the engine exhaust gas into mechanical energy to drive the compressor. The exhaust gas applies pressure and temperature drop between a volute inlet 16 and an outlet. This pressure is converted by the turbine 10 into energy to drive the turbine wheel 12.

The VTV turbine housing 14 includes a volute 20 with a spiral shape with a curved portion 22 that decreases in size from the volute inlet 16 toward the turbine wheel 12. The volute 20 surrounds the outer circumference of the turbine wheel 12.

The VTV turbine housing 14 has dividing vanes 24 in the curved portion 22 of the volute 20 for use with a mixed-flow or axial-flow turbine 10 to deliver appropriate gas flow to a non-radial turbine wheel 12. The volute 20 with dividing vanes 24 in the curved portion 22 in combination with an axial or mixed-flow turbine 10 assists with improved exhaust gas delivery. The dividing vanes 24 can define an outer volute portion 26 and an inner volute portion 28.

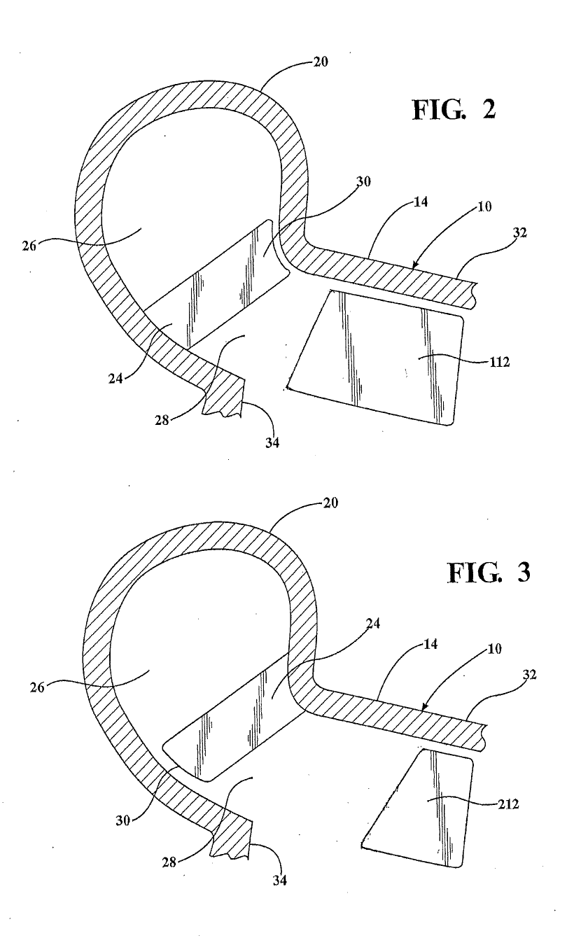

The dividing vanes 24 can be cast into either side of the volute 20. FIG. 2 shows the dividing vanes 24 extending from the hub-side wall 34. A distal free end 30 of the dividing vane 24 is adjacent a shroud wall 32 and an example mixed-flow turbine wheel 112. FIG. 3 shows dividing vanes 24 extending from the shroud wall 32 and the distal free end 30 adjacent to the hub-side wall 34 with an example axial-flow turbine wheel 212. In the second case, a heat shield could be designed to be the sealing surface, including a multi-piece heat shield that could flex when the dividing vanes 24 press on the heat shield with expansion due to temperature increases. It is understood that the non-radial turbine wheel 12 could be either the axial-flow turbine wheel 112 or the mixed-flow turbine wheel 212 in combination with the dividing vanes 24 on either wall 32 or 34.

The dividing vanes 24 can be tilted relative to the axis of rotation allowing a surface on the opposite wall for both thermal growth and sealing the vane tips.

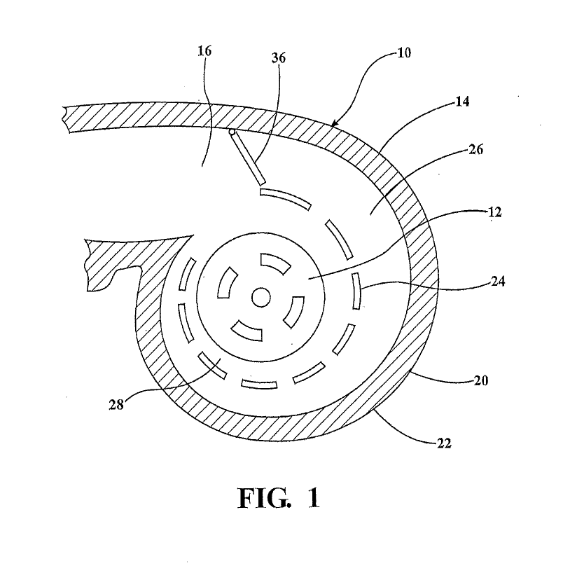

A valve 36 can be incorporated into the volute inlet 16 to control exhaust gas flow, primarily with respect to the outer volute portion 26 as seen in FIG. 1. The valve 36 is preferably hinged to pivot on the turbine housing 14 to direct gas flow to only the inner volute portion 28 when closed or to both the inner volute portion 28 and outer volute portion 26 when open. The valve 36 can also be incorporated as part of the first vane of the dividing vanes 24 at the volute inlet 16. The flow of exhaust gas to just the inner volute portion 28 or to both the outer and inner volute portions 26 and 28 affects the speed of rotation of the turbine wheel 12.

The presently disclosed VTV turbine housing 14 with dividing vanes 24 in the curved portion 22 controls exhaust gas flow and improves exhaust gas recirculation as part of a mixed-flow or axial-flow turbine 10 while maintaining the benefits of lower inertia. Also, the VTV turbine housing 14 with dividing vanes 24 in the curved portion 22 of the volute 20 accommodates a smaller overall turbine 10.

The invention has been described in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed is:

1. A turbocharger using exhaust gas recirculation comprising a turbine (10) having a non-radial turbine wheel (12) and a variable turbine volute housing (14) with a curved portion (22), the curved portion (22) incorporating dividing vanes (24) forming an inner volute portion (28) and an outer volute portion (26); and
a valve (36) that controls exhaust gas flow to one or both of the inner volute portion (28) and the outer volute portion (26) for use with the turbine (10) as mixed-flow or axial-flow.

2. The turbocharger of claim 1 wherein the exhaust gas flow approaches the turbine wheel (12) in an axial direction.

3. The turbocharger of claim 1 wherein the inner volute portion (28) and the outer volute portion (26) are defined by a hub-side wall (34) and a shroud wall (32).

4. The turbocharger of claim 3 wherein the dividing vanes (24) extend from the hub-side wall (34) and have free distal ends (30) adjacent to the shroud wall (32).

5. The turbocharger of claim 3 wherein the dividing vanes (24) extend from the shroud wall (32) and have free distal ends (30) adjacent to the hub-side wall (34).

6. The turbocharger of claim 1 wherein the dividing vanes (24) are tilted relative to an axis of rotation of the non-radial turbine wheel (12).

7. A turbocharger using exhaust gas recirculation comprising an axial-flow turbine (10) having a non-radial turbine wheel (12) and a variable turbine volute housing (14) with a curved portion (22) that incorporates dividing vanes (24) extending from a housing wall (32 or 34) and the dividing vanes (24) each having a distal free end (30), the dividing vanes (24) forming an inner volute portion (28) and an outer volute portion (26); and
a pivoting valve (36) that controls exhaust gas flow to one or both of the inner volute portion (28) and the outer volute portion (26) for use with the axial-flow turbine (10) wherein the exhaust gas flow approaches the non-radial turbine wheel (12) in an axial direction.
